(19) United States
(12) Patent Application Publication
(10) Pub. No.: US 2026/0279958 A1
(43) Pub. Date: Sep. 17, 2026

(54) VEHICLE BATTERY ASSEMBLY

(71) Applicants: HYUNDAI MOTOR COMPANY, SEOUL (KR); KIA CORPORATION, SEOUL (KR)

(72) Inventor: Gyung Hoon Shin, Hwaseong-si (KR)

(73) Assignees: HYUNDAI MOTOR COMPANY, SEOUL (KR); KIA CORPORATION, SEOUL (KR)

(21) Appl. No.: 19/280,087

(22) Filed: Jul. 24, 2025

(30) Foreign Application Priority Data
Mar. 13, 2025 (KR) 10-2025-0032900

(51) Int. Cl. H01M 10/6556; H01M 10/613; H01M 10/625; H01M 50/209

(52) U.S. Cl. CPC H01M 10/6556; H01M 10/613; H01M 10/625; H01M 50/209; H01M 2220/20

(57) ABSTRACT

Disclosed is a vehicle battery assembly including a case having a plurality of module accommodation spaces formed therein. Each module accommodation space has an open upper portion. The vehicle battery assembly further includes a plurality of battery modules respectively inserted into the module accommodation spaces, a plurality of cooling channels respectively coupled to upper sides of the respective battery modules, and a reinforcing bracket configured to fix the cooling channels to the case.

### CROSS-REFERENCE TO THE RELATED APPLICATION(S)

This application claims priority from Korean Patent Application No. 10-2025-0032900, filed on Mar. 13, 2025, in the Korean Intellectual Property Office, the disclosure of which is incorporated herein by reference in its entirety.

### TECHNICAL FIELD

The present disclosure relates to a technique for mounting a battery in an electric vehicle and the like.

### BACKGROUND

Hybrid vehicles and electric vehicles have batteries mounted therein. Generally, a number of batteries are mounted in a vehicle to improve vehicle range, and the batteries mounted in the vehicle should be reliably and stably cooled to prevent overheating of the batteries. In addition, the batteries mounted in the vehicle are configured to be protected from external impacts and the like, and the batteries should be maintained in an acceptable condition.

This section is for understanding of the general background of the disclosure, and is not an acknowledgement or any form of suggestion that this information forms the art known to a person skilled in the art.

### SUMMARY

An aspect of the present disclosure provides a vehicle battery assembly configured to increase the number of battery cells mounted in a vehicle, to secure reliable and stable cooling performance for the battery cells, to safely protect the battery cells from external impact and the like, and to maintain the battery cells in an acceptable condition.

The aspects of the present disclosure are not limited to the above-mentioned aspects, and other technical aspects not mentioned herein may be understood by those skilled in the art to which the present disclosure pertains.

In accordance with an aspect of the present disclosure, a vehicle battery assembly is provided. The vehicle battery assembly includes a case having a plurality of module accommodation spaces formed therein. Each of the module accommodation spaces has an open upper portion. The vehicle battery assembly further includes a plurality of battery modules (e.g., respectively) inserted into the module accommodation spaces, a plurality of cooling channels (e.g., respectively) coupled to upper sides of the respective battery modules, and a reinforcing bracket configured to fix the cooling channels to the case.

The cooling channels may be formed to respectively cover and seal upper sides of the module accommodation spaces in the case.

The module accommodation spaces may be partitioned by a plurality of partition wall assemblies provided in the case and arranged in parallel with each other.

The partition wall assembly may include a frame member having a linearly extending closed cross section, and a partition wall inserted into a space formed between the frame member and the case.

The case may have a foam pad provided on an upper side of a bottom surface thereof. The foam pad may be configured for a lower end of the partition wall to be inserted thereinto. The frame member may have a partition wall insertion groove formed in a lower side thereof. The partition wall insertion groove may be configured for an upper end of the partition wall to be inserted thereinto.

The partition wall insertion groove may have a frame pad provided therein and the frame pad may be configured to elastically surround and support the upper end of the partition wall.

The case may include a lower case surrounding lower sides of the battery modules and an upper tray coupled to an upper side of the lower case, the upper tray may be formed to have respective openings on upper sides of the module accommodation spaces, and the frame member of the partition wall assembly may be coupled to a lower side of a bridge part serving as a partition between two adjacent openings of the upper tray.

An edge of the cooling channel may be coupled to an upper surface of the upper tray with a seal formed therebetween, the edges of two adjacent cooling channels may be disposed on an upper side of the bridge part to be aligned in a common plane, and the reinforcing bracket may be installed on upper sides of the two adjacent cooling channels disposed on the upper side of the bridge part so as to provide pressure to press the two adjacent cooling channels against the bridge part.

The reinforcing bracket may have a plurality of coupling members coupled thereto by passing therethrough. Each of the coupling members may fix the reinforcing bracket to the frame member.

The reinforcing bracket may have a busbar accommodation groove formed in an upper side thereof, and the busbar accommodation groove may be configured to accommodate a busbar therein.

A vertical thickness of the reinforcing bracket may be formed such that a height of an upper end of the coupling member or the busbar is lower than a height of an upper end of the cooling channel.

The reinforcing bracket may be installed in recessed portions respectively formed in edges of two adjacent cooling channels, and a bracket pad may be provided between the reinforcing bracket and the cooling channel.

A frame rib having a cross-sectional shape extending in a vertical direction may be formed to be integrated with the frame member within the cross section of the frame member, and the reinforcing bracket may have a bracket rib formed to be integrated therewith and provided on an upper surface thereof, the bracket rib may be formed to protrude upwards so as to overlap at least a part of the frame rib in the vertical direction.

Each of the battery modules may include a plurality of frame plates disposed in parallel with each other so as to be perpendicular to the frame member.

A blocking member may be provided between a lower end of the frame plate and a bottom surface of the case so as to partition a space formed between the battery module and the case.

The frame plate may have a terminal groove integrally formed therein, the terminal groove may be formed to be open upwards so as to form a space allowing a module terminal part to be connected to a busbar.

The frame plate may have a terminal groove provided therein and formed to be open upwards, and the terminal groove may have a fuse installed therein, the fuse may be configured to cut off an electrical connection state of a busbar.

The frame plate may have a terminal groove provided therein and formed to be open upwards, the cooling channel may have a terminal hole formed therein and configured to communicate with the terminal groove in the frame plate, the busbar may be inserted into the terminal groove through the terminal hole, and the terminal hole may be sealed by a busbar cover.

In accordance with another aspect of the present disclosure, there is provided a vehicle having the vehicle battery assembly mounted therein.

The cooling channel of the vehicle battery assembly may be located between a floor panel of a vehicle body and the battery module.

### BRIEF DESCRIPTION OF THE DRAWINGS

The above and other aspects and features of the present disclosure may be understood from the following detailed description taken in conjunction with the accompanying drawings, in which:

FIG. 1 is a view showing a vehicle battery assembly according to the present disclosure;

FIG. 2 is a view showing a case in FIG. 1;

FIG. 3 is a view showing a lower case and an upper tray forming the case;

FIG. 4 is a view showing a battery module in FIG. 1;

FIG. 5 is a cross-sectional view taken along line V-V in FIG. 1;

FIG. 6 is a view showing a state in which a reinforcing bracket and a busbar in FIG. 5 are removed, as observed from above;

FIG. 7 is a view showing another example embodiment of a frame member and the reinforcing bracket in FIG. 5;

FIG. 8 is a view showing a blocking member provided between a frame plate and the lower case;

FIG. 9 is a detailed view of a portion IX in FIG. 1;

FIG. 10 is a view showing a state in which a busbar cover is removed in FIG. 9;

FIG. 11 is a cross-sectional view taken along line F11-F11 in FIG. 10;

FIG. 12 is a view showing an example in which a fuse capable of blocking an electrical connection state of the busbar is installed; and

FIG. 13 is a cross-sectional view showing an example in which the battery assembly according to the present disclosure is coupled to a vehicle body.

### DETAILED DESCRIPTION

In describing the example embodiments disclosed herein, when it is determined that a detailed description may obscure the gist of the example embodiments disclosed in this specification, the detailed description thereof may be omitted. Further, it should be understood that the accompanying drawings are illustrated to describe the example embodiments disclosed in this specification, and therefore, the technical idea disclosed in this specification is not limited by the accompanying drawings. Further, it should be noted that the accompanying drawings include (e.g., all) modifications, equivalents, and substitutes that fall within the spirit and technical scope of the present disclosure.

In the present disclosure, terms such as “first” and/or “second” may be used to describe various components, but the components are not limited by the terms. The terms are used for the purpose of distinguishing one component from other components.

In this specification, an expression in a singular form also includes the plural sense, unless specified otherwise in context.

It should be understood that expressions such as “comprise” and “have” in this specification are intended to designate the presence of indicated features, numbers, steps, operations, components, parts, or combinations thereof, but may not exclude the presence or addition of one or more features, numbers, steps, operations, components, parts, or combinations thereof.

Hereinafter, the suffixes “module”, “unit”, and “part” for components used in the following description are provided for facilitation of preparing this specification. Therefore, the suffixes themselves do not have significant meanings or roles.

When one component is referred to as being “connected” or “coupled” to another component, the one component may be directly connected or coupled to the other component, but it should be understood that other components may be present therebetween. On the other hand, when the one component is referred to as being “directly connected” or “directly coupled” to the other component, it should be understood that no other components are present therebetween.

Any number of components or a variety of components in any of the configurations described herein may be included in the present disclosure. The components may include any combination of the features described herein, and may be arranged in any of the various configurations described herein. The structure and arrangement of components of the present disclosure, as well as the concepts regarding the use and operation of the components, may be applied not only to the example embodiments discussed herein, but also to any number of example embodiments in any combination. Example embodiments including those having various features in various arrangements are described below with reference to the drawings.

Hereinafter, various example embodiments disclosed herein will be described in detail with reference to accompanying drawings, and regardless of the drawing symbols, the same or similar components may be denoted by the same reference numerals, and redundant descriptions thereof may be omitted.

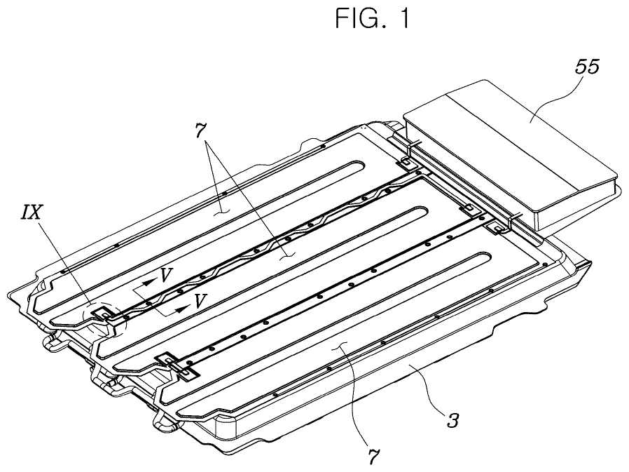

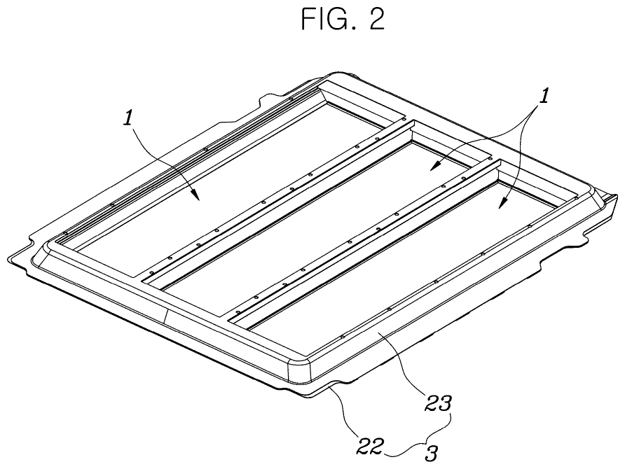

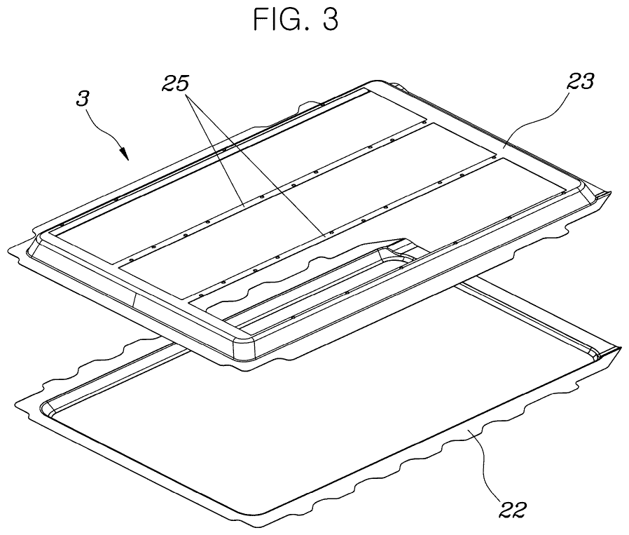

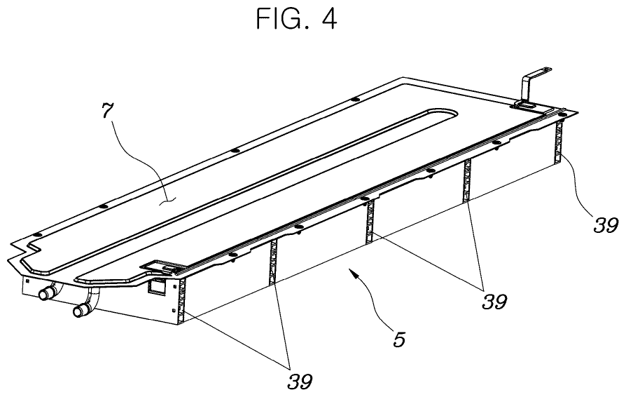

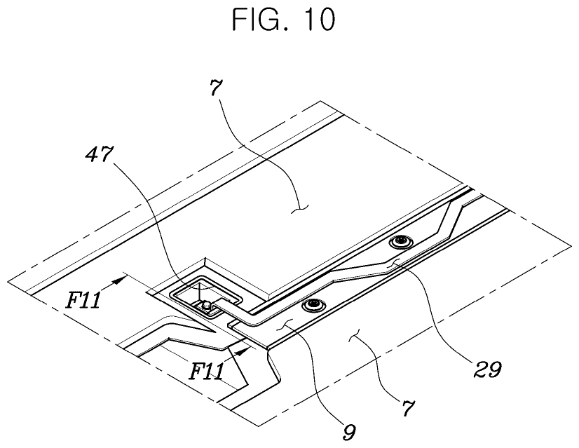

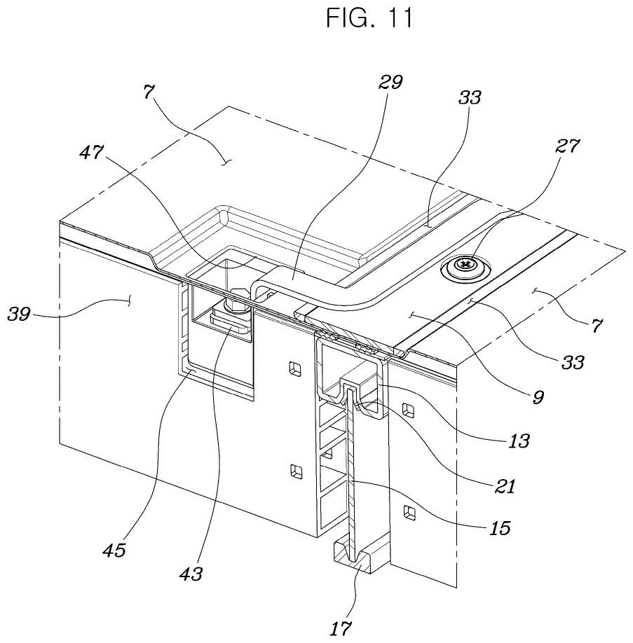

Referring to FIGS. 1 to 13, a vehicle battery assembly according to the present disclosure includes a case 3 having a plurality of module accommodation spaces 1 formed therein. Each of the module accommodation spaces 1 has an open upper portion. The vehicle battery assembly further includes a plurality of battery modules 5 respectively inserted into the module accommodation spaces 1, a plurality of cooling channels 7 respectively coupled to the upper sides of the respective battery modules 5, and a reinforcing bracket 9 configured to fix (e.g., couple) the cooling channels 7 to the case 3.

For reference, FIG. 1 shows an electric component module 55 in which various electric components electrically connected to the battery modules 5 are integrated.

The cooling channel 7 is configured to be assembled with or disassembled from the case 3 by being (e.g., integrally) coupled to the upper side of the battery module 5 using a fastening means such as an adhesive 2 or a screw.

That is, in the present disclosure, the battery module 5 integrated with the cooling channel 7 is configured to be assembled with or disassembled from the case 3 through an upper opening of the module accommodation space 1 in the case 3.

Therefore, the battery assembly of the present disclosure may be separated from a vehicle body 11, and then the battery module 5 integrated with the cooling channel 7 may be separated from the case 3 in the upward direction to perform (e.g., necessary) maintenance on one or more components of the battery assembly.

The cooling channels 7 are formed to (e.g., respectively) cover and seal the upper sides of the module accommodation spaces 1 in the case 3.

That is, the cooling channel 7 cools the battery module 5 and seals the upper opening of the module accommodation space 1, thereby functioning as a cover configured to substantially prevent moisture or foreign substances from infiltrating the battery module 5.

In the example embodiment, the module accommodation spaces 1 are formed by partitioning the case 3 into a plurality of spaces using a plurality of partition wall assemblies, provided in parallel with each other, in the case 3.

The partition wall assembly is configured to include a frame member 13 having a shape in which a closed cross-section linearly extends, and a partition wall 15 inserted into a space formed between the frame member 13 and the case 3.

In addition, a foam pad 17 configured for the lower end of the partition wall 15 (e.g., to be inserted thereinto) is provided on the upper side of the bottom surface of the case 3. A partition wall insertion groove 19 configured for the upper end of the partition wall 15 (e.g., to be inserted thereinto) is formed in the lower side of the frame member 13, and a frame pad 21 configured to elastically surround and support the upper end of the partition wall 15 is provided in the partition wall insertion groove 19.

Accordingly, the upper end and the lower end of the partition wall 15 are respectively fixedly supported by the frame pad 21 and the foam pad 17. In this manner, the adjacent module accommodation spaces 1 are partitioned by the frame member 13.

The module accommodation spaces 1 are (e.g., completely) isolated from each other by the partition wall assemblies. Accordingly, even if a fire occurs in one battery module 5, it is possible to (e.g., effectively) prevent the fire from spreading to other adjacent battery modules 5.

In the present example embodiment, the case 3 includes a lower case 22 surrounding the lower sides of the battery modules 5, and an upper tray 23 coupled to the upper side of the lower case 22 and formed to have (e.g., respective) upper openings of the module accommodation spaces 1. The frame member 13 of the partition wall assembly is coupled to the lower side of a bridge part 25 serving as a partition between two adjacent openings of the upper tray 23.

The edge of the cooling channel 7 is coupled to the upper side of the upper tray 23 with a seal formed therebetween, thereby ensuring watertightness of the module accommodation space 1 by preventing water from entering.

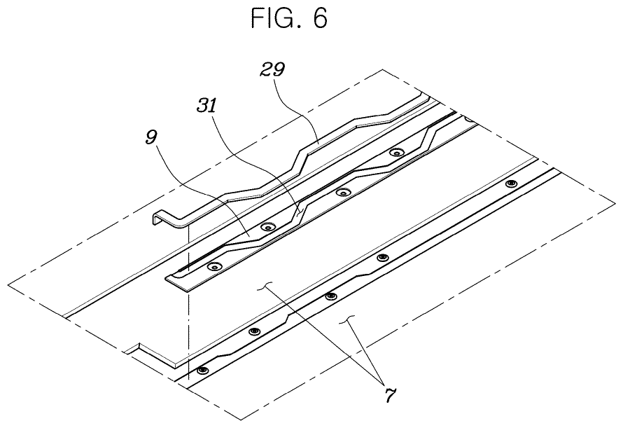

In addition, the edges of two adjacent cooling channels 7 are disposed on the upper side of the bridge part 25 to be aligned in a common plane, as shown, and the reinforcing bracket 9, as shown in FIG. 6, is installed on the upper sides of the two adjacent cooling channels 7 disposed on the upper side of the bridge part 25 so as to provide pressure to press the two adjacent cooling channels 7 against the bridge part 25.

A plurality of coupling members 27 is coupled to the reinforcing bracket 9 (e.g., by penetrating the same), and each of the coupling members 27 fixes (e.g., couples) the reinforcing bracket 9 to the frame member 13.

Therefore, the cooling channel 7 and the bridge part 25 located between the reinforcing bracket 9 and the frame member 13 are compressed against each other, thereby (e.g., reliably) providing (e.g., securing) sealing performance of the module accommodation space 1. Further, the frame member 13, the bridge part 25, the cooling channel 7, and the reinforcing bracket 9 are formed to be integrated with each other by the coupling member 27, thereby (e.g., reliably) providing (e.g., securing) structural rigidity and load distribution. Through such a structural configuration, it is possible to reduce vibration of a battery assembly and substantially prevent deformation thereof.

In the present example embodiment, a busbar accommodation groove 31 configured to accommodate a busbar 29 therein is formed in the upper side of the reinforcing bracket 9.

The busbar 29 is used (e.g., employed) for electrical connection between the battery modules 5. Since the busbar 29 is mounted in the busbar accommodation groove 31 in the reinforcing bracket 9, the structure of the busbar 29 may be protected, and replacement of the busbar 29 may be (e.g., easily) performed.

Therefore, after the battery assembly is separated from the vehicle body 11, the busbar 29 and the reinforcing bracket 9 are (e.g., sequentially) removed. Thereafter, the battery modules 5 integrated with the respective cooling channels 7 are separated from the upper side of the case 3, and then maintenance may be (e.g., easily) performed.

In addition, (e.g., one) reinforcing bracket 9 may (e.g., simultaneously) fix (e.g. couple) two cooling channels 7 adjacent to each other, thereby reducing the number of (e.g., required) parts and (e.g., reliably) providing (e.g., securing) sealing performance of the module accommodation space 1.

The vertical thickness of the reinforcing bracket 9 is formed such that the height of the upper end of the coupling member 27 or the busbar 29 is lower than the height of the upper end of the cooling channel 7.

That is, in the cross-sectional structure of the cooling channel 7, the cooling channel 7 is coupled to the upper tray 23 in a state of forming a (e.g., certain) space therebetween in the vertical direction so as to allow refrigerant to circulate through the space, and the edge thereof is in close contact with the upper tray 23. Here, portions of the cooling channel 7, other than the above-mentioned edge, are substantially formed to (e.g., slightly) protrude upwards. In this case, when the reinforcing bracket 9, the coupling member 27, and the busbar 29 are installed in grooves respectively formed in the edges of the two adjacent cooling channels 7, the uppermost end of each of the reinforcing bracket 9, the coupling member 27, and the busbar 29 may be lower than the respective upper ends of the two cooling channels 7.

The reinforcing bracket 9 may be formed to have a thickness having (e.g., sufficient) rigidity within a range in which the above-mentioned structural conditions are satisfied.

A bracket pad 33 is provided between the reinforcing bracket 9 and the cooling channel 7. Here, when load is input from the outside through the cooling channel 7, the load may be (e.g., smoothly) transferred and distributed to the reinforcing bracket 9, and the section modulus of the reinforcing bracket 9 and the periphery thereof may be increased.

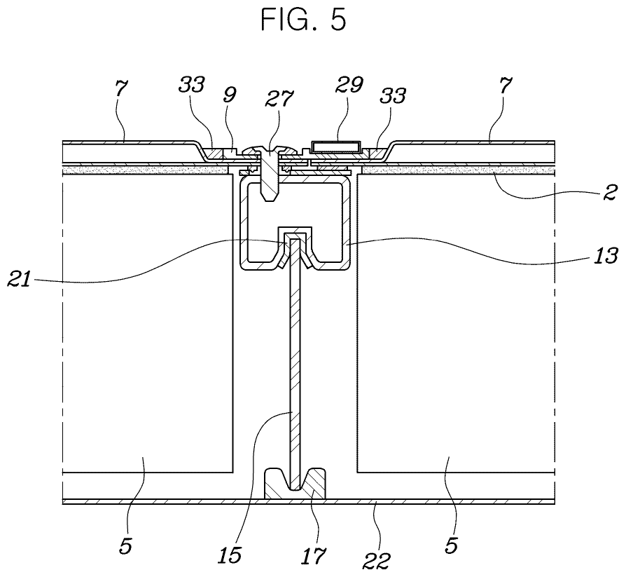

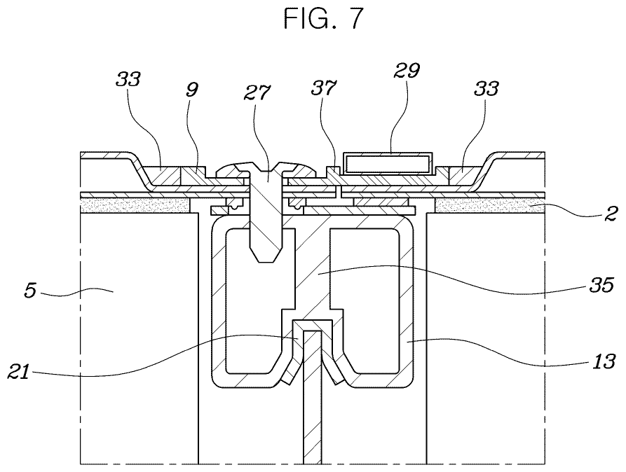

Referring to FIG. 7, as compared to FIG. 5, a frame rib 35 having a cross-sectional shape extending in the vertical direction is formed to be integrated with the frame member 13 within the cross section of the frame member 13, and the reinforcing bracket 9 has a bracket rib 37 configured to be integrated with the upper side thereof and formed to protrude upwards so as to overlap at least a part of the frame rib 35 in the vertical direction.

Such a structural configuration provides (e.g., enables) the frame member 13 and the reinforcing bracket 9 to form a larger section modulus with the bridge part 25 and the cooling channel 7. In this manner, the battery assembly may secure more robust structural rigidity against external loads.

In the example embodiment, each battery module 5 is configured to include a plurality of frame plates 39 disposed in parallel (e.g., with each other) so as to be perpendicular to the frame member 13.

That is, the battery module 5 has a configuration in which a plurality of battery cells and a plurality of frame plates 39 interposed therebetween overlap each other. Here, since the frame plate 39 is disposed perpendicular to the frame member 13 and the partition wall 15, as a result, the interior of the case 3 may be partitioned in a grid shape by the partition wall assembly and the frame plate 39, and a structural configuration capable of protecting the battery cells arranged in the case 3 is provided.

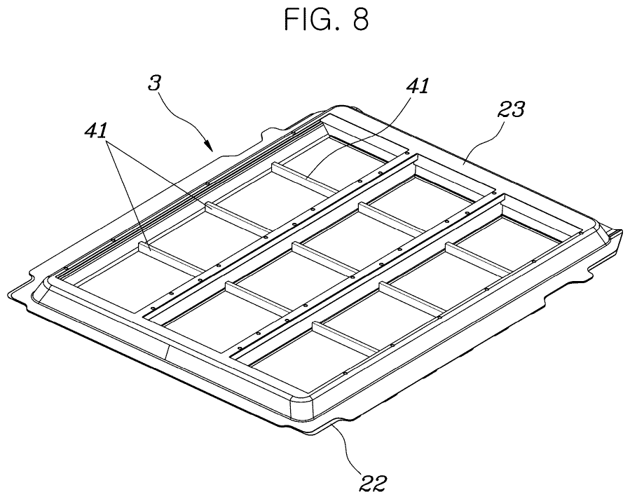

FIG. 8 is a view showing another example embodiment of the present disclosure. Since a blocking member 41 is provided between the lower end of the frame plate 39 and the bottom surface of the case 3, a space formed between the battery module 5 and the case 3 may be partitioned.

A space is formed between the lower end of the battery module 5 and the bottom surface of the case 3, and the blocking member 41 blocks the space formed therebetween. Accordingly, the spaces partitioned by the frame plate 39 and the blocking member 41 may be separately provided in the (e.g., same) module accommodation space 1. Through such a structural configuration, when a fire occurs in a battery cell disposed in a (e.g., certain) space, the fire in the battery cell is substantially prevented from spreading to an adjacent battery cell disposed in another space.

In order to (e.g., more effectively) prevent a fire from spreading to other adjacent battery cells, a separate member that blocks a gap between the partition wall 15 and the battery module 5 may be additionally used.

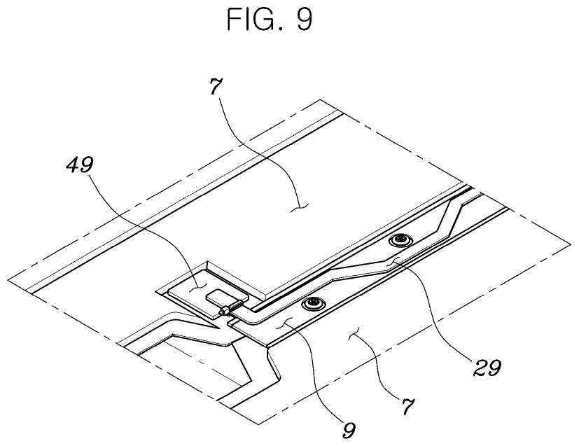

Referring to FIGS. 9 to 11, the frame plate 39 has a terminal groove 45 integrally formed therein, and the terminal groove 45 is formed to be open upwards so as to form a space allowing the module terminal part 43 to be connected to the busbar 29.

In addition, a terminal hole 47 communicating with the terminal groove 45 in the frame plate 39 is formed in the cooling channel 7, the busbar 29 is inserted into the terminal groove 45 through the terminal hole 47, and the terminal hole 47 is configured to be sealed by a busbar cover 49.

Therefore, a connection part configured to connect the busbar 29 to the module terminal part 43 is (e.g., safely) accommodated in a space formed between the busbar cover 49 and the terminal groove 45 at the lower side of the cooling channel 7, thereby implementing a compact assembly state. Furthermore, when the busbar 29 is disassembled from the module terminal part 43, the busbar cover 49 is removed, and then the busbar 29 may be (e.g., easily) separated from the module terminal part 43.

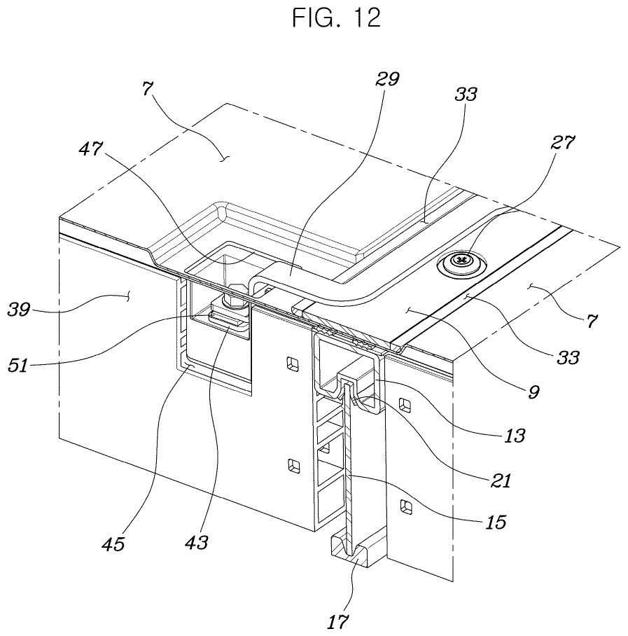

In addition, as shown in FIG. 12, a fuse 51 capable of cutting off the electrical connection state of the busbar 29 is installed in the terminal groove 45 in the frame plate 39, thereby (e.g., effectively) protecting the fuse 51 from the outside. Further, when a (e.g., high) current is applied to the busbar 29, current blocking may be (e.g., rapidly) performed through the fuse 51, thereby further improving the electrical safety of the battery assembly.

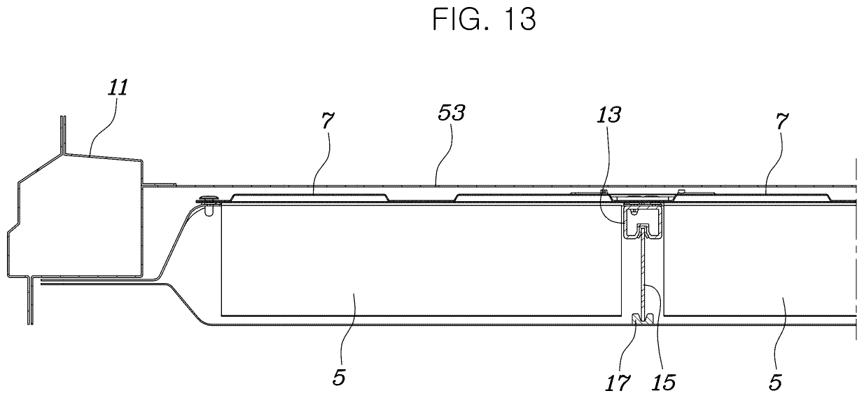

In the battery assembly, the cooling channel 7 may be disposed adjacent to the lower side of a floor panel 53 of the vehicle body 11, as shown in FIG. 13.

In this case, the cooling channel 7 is positioned between the floor panel 53 and the battery module 5, and no components, other than the cooling channel 7, are interposed between the floor panel 53 and the battery module 5, thereby securing a degree of freedom to increase the number of battery cells mounted in the vehicle.

The present disclosure provides a vehicle battery pack capable of increasing the number of battery cells mounted in a vehicle, securing (e.g., smooth and stable) cooling performance, (e.g., safely) protecting the vehicle battery pack from external impact, and providing improved maintenance performance.

The present disclosure is not limited herein, and other variations may be understood by those skilled in the art to which the present disclosure pertains from the detailed description of the example embodiments.

Although example embodiments of the present disclosure have been disclosed for illustrative purposes, those skilled in the art may appreciate that various modifications, additions, and substitutions are possible, without departing from the scope and spirit of the disclosure as disclosed in the accompanying claims.

What is claimed is:

1. A vehicle battery assembly comprising:
a case having a plurality of module accommodation spaces formed within the case, each of the module accommodation spaces has an open upper portion;
a plurality of battery modules inserted into the module accommodation spaces;
a plurality of cooling channels coupled to upper sides of the battery modules; and
a reinforcing bracket configured to couple the plurality of cooling channels to the case.

2. The vehicle battery assembly according to claim 1, wherein the cooling channels are formed to cover and seal upper sides of the module accommodation spaces in the case.

3. The vehicle battery assembly according to claim 1, wherein the module accommodation spaces are partitioned by a plurality of partition wall assemblies provided in the case and arranged in parallel with respect to each other.

4. The vehicle battery assembly according to claim 3, wherein each partition wall assembly comprises:
a frame member having a linearly extending closed cross-section; and
a partition wall inserted into a space formed between the frame member and the case.

5. The vehicle battery assembly according to claim 4, wherein:
the case includes a foam pad provided on an upper side of a bottom surface of the case, the foam pad configured for a lower end of the partition wall to be inserted into the foam pad; and
the frame member has a partition wall insertion groove formed in a lower side of the frame member, the partition wall insertion groove configured for an upper end of the partition wall to be inserted into the partition wall insertion groove.

6. The vehicle battery assembly according to claim 5, wherein a frame pad is provided in the partition wall insertion groove, and the frame pad is configured to elastically surround and support the upper end of the partition wall.

7. The vehicle battery assembly according to claim 5, wherein:
the case comprises:
a lower case surrounding lower sides of the battery modules; and
an upper tray coupled to an upper side of the lower case, the upper tray formed to have openings on upper sides of the module accommodation spaces; and
the frame member of the partition wall assembly is coupled to a lower side of a bridge part serving as a partition between two adjacent openings of the upper tray.

8. The vehicle battery assembly according to claim 7, wherein:
an edge of at least one of the cooling channels is coupled to an upper surface of the upper tray with a seal formed between the edge of the at least one cooling channel and the upper surface of the upper tray;
the edges of two adjacent cooling channels are disposed on an upper side of the bridge part aligned in a common plane; and
the reinforcing bracket is coupled to upper sides of the two adjacent cooling channels disposed on the upper side of the bridge part providing pressure to press the two adjacent cooling channels against the bridge part.

9. The vehicle battery assembly according to claim 4, wherein the reinforcing bracket has a plurality of coupling members coupled to and passing through the reinforcing bracket, and each of the coupling members couples the reinforcing bracket to the frame member.

10. The vehicle battery assembly according to claim 9, wherein the reinforcing bracket has a busbar accommodation groove formed in an upper side, the busbar accommodation groove is configured to accommodate a busbar.

11. The vehicle battery assembly according to claim 9, wherein a vertical thickness of the reinforcing bracket is formed such that a height of an upper end of at least one of the coupling members or a busbar is lower than a height of an upper end of at least one of the cooling channels.

12. The vehicle battery assembly according to claim 9, wherein:
the reinforcing bracket is installed in recessed portions formed in edges of two adjacent cooling channels; and
a bracket pad is provided between the reinforcing bracket and at least one of the cooling channels.

13. The vehicle battery assembly according to claim 9, wherein:
a frame rib having a cross-sectional shape extending in a vertical direction is formed to be integrated with the frame member within a cross-section of the frame member; and
the reinforcing bracket has a bracket rib provided on an upper surface of the reinforcing bracket, the bracket rib is formed to protrude upwards to overlap at least a part of the frame rib in the vertical direction.

14. The vehicle battery assembly according to claim 4, wherein each of the battery modules comprises a plurality of frame plates disposed in parallel, and the frame plates are perpendicular to the frame member.

15. The vehicle battery assembly according to claim 14, wherein a blocking member is provided between a lower end of the frame plate and a bottom surface of the case to partition a space formed between at least one of the battery modules and the case.

16. The vehicle battery assembly according to claim 14, wherein at least one of the frame plates has a terminal groove, the terminal groove formed to be open upwards to form a space allowing a module terminal part 43 to be connected to a busbar.

17. The vehicle battery assembly according to claim 14, wherein:
at least one of the frame plates has a terminal groove and formed to be open upwards; and
the terminal groove has a fuse, the fuse configured to cut off an electrical connection state of a busbar.

18. The vehicle battery assembly according to claim 14, wherein:
at least one of the frame plates has a terminal groove and is formed to be open upwards;
at least one of the cooling channels has a terminal hole and is configured to communicate with the terminal groove in the at least one frame plate;
a busbar is inserted into the terminal groove through the terminal hole; and
the terminal hole is sealed by a busbar cover.

19. A vehicle having a vehicle battery assembly, the vehicle battery assembly comprising:
a case having a plurality of module accommodation spaces formed within the case, each of the module accommodation spaces has an open upper portion;
a plurality of battery modules inserted into the module accommodation spaces;
a plurality of cooling channels coupled to upper sides of respective battery modules; and
a reinforcing bracket configured to couple the plurality of cooling channels to the case.

20. The vehicle according to claim 19, wherein at least one of the cooling channels of the vehicle battery assembly is between a floor panel of a vehicle body and at least one of the battery modules.
